(19) United States
(12) Patent Application Publication
(10) Pub. No.: US 2025/0375628 A1
(43) Pub. Date: Dec. 11, 2025

(54) Configurable Demand Regulator

(71) Applicant: Dräger Safety AG & Co. KGaA, Lübeck (DE)

(72) Inventors: Robert Miller, Whitley Bay (GB); Paul James Ringer, Consett (GB)

(21) Appl. No.: 19/221,102

(22) Filed: May 28, 2025

(30) Foreign Application Priority Data
Jun. 6, 2024 (EP) 24180575.3

(51) Int. Cl. A62B 9/02; A62B 9/04

(52) U.S. Cl. CPC A62B 9/022; A62B 9/04

(57) ABSTRACT

There is disclosed a demand regulator for a breathing apparatus comprising: a first connector point; and a second connector point, wherein the first connector point and the second connector point are each configured to connect to a universal connector. Also disclosed is a breathing apparatus comprising a demand regulator or a demand regulator system.

### CROSS-REFERENCE TO RELATED APPLICATIONS

This application claims the priority to European Patent Application No. 24180575.3, filed on Jun. 6, 2024, and titled “Configurable Demand Regulator,” which is hereby incorporated by reference in its entirety for all nonlimiting purposes.

### BACKGROUND

Self-contained breathing apparatus (SCBA) products are typically used by fire fighters to provide safe breathing gas in environments with contaminated atmospheres. Typical SCBA systems generally include a tank for storing pressurised breathing gas, a frame to support the tank on the user's back, one or more breathing gas pressure reducers, a face mask, and a demand regulator. The demand regulator supplies breathing gas to the user on demand as they inhale through the face mask.

Existing demand regulator typically include a breathing gas input connector on one side of the demand regulator. In some examples, a bypass valve may also be installed on the demand regulator. A breathing gas hose will generally be connected to the breathing gas input connector in order to supply breathing gas to the demand regulator. As the breathing gas input connector is generally positioned on one side of the demand regulator, the breathing gas hose is generally routed out of the demand regulator and around one side of the user. Generally, the side around which the hose is routed is the same for all users. Similarly, when a bypass valve is installed, it is generally positioned in a fixed position on the demand regulator. Therefore, as different users will generally be either left or right handed, not all users will be able to easily use their dominant hand to securely grasp the demand regulator without the breathing gas delivery tube causing an obstruction. Similarly, not all users will be able to easily use their dominant hand to grasp and control the bypass valve.

It will therefore be appreciated that there is a need for an improved type of demand regulator.

### SUMMARY

In a first aspect, there is provided a demand regulator for a breathing apparatus comprising: a first connector point; and a second connector point, wherein the first connector point and the second connector point are each configured to connect to a universal connector.

The first and second connector points may be located in different positions on the demand regulator. The connector points may be connector ports (i.e., female connectors or receptacles) for receiving the universal connector. The connector points may be connector fittings (i.e., male connectors) for being received by the universal connector. Likewise, the universal connector may be a port (i.e., female connector) or a fitting (i.e., a male connector) respectively. It will be understood that ‘universal connector’ refers to any connector that can connect to both the first and second connector points.

The first connector point and the second connector point may each have an identical shape. The term ‘identical shape’ may include substantially identical and/or functionally identical, meaning that the first and second connector points each share substantially and/or functionally the same geometric features, such that they each may interface with the universal connector in the same way. The first connector point and the second connector point may be shape the same or substantially the same. The first connector point and the second connector point may each be shaped to connect to connectors of the same or substantially the same shape.

The first connector point and the second connector point may each be in fluid communication with a manifold of the demand regulator. The first and second connector point and the manifold may each be in fluid connection with an internal cavity of the demand regulator via the manifold, such that breathing gas is permitted to flow between both the first connector point and the second connector point and the internal cavity via the manifold. Breathing gas flow between the manifold and the internal cavity may be controlled and/or restricted by a valve.

The first connector point and the second connector point may be on opposite sides of the demand regulator. The first connector point and the second connector point may be positioned on the demand regulator facing in substantially opposite directions.

The first connector point may be disposed on a first lateral side of the demand regulator. The second connector point may be disposed on a second lateral side of the demand regulator. The second lateral side may be opposite the first lateral side.

References to ‘lateral side’ of the demand regulator should be understood to mean a side other than the front, back, top, or bottom of the demand regulator with respect to the user when the demand regulator is in use, i.e., a left or right side. The back of the demand regulator may be the side comprising a connection for connecting the demand regulator to a face mask. The front of the demand regulator may be opposite the back of the demand regulator, which faces generally forward in use. The first lateral side should be understood to mean a side of the demand regulator extending approximately perpendicularly from a front side of the demand regulator to the left or right. The second lateral side should be understood to mean a side of the demand regulator extending approximately perpendicularly from the front side of the demand regulator to the left or right. The second lateral side may be parallel to the first lateral side.

It will be understood that a ‘side’ of the demand regulator may be an external surface of the demand regulator that faces generally to the right or left with respect to the user in use. A ‘side’ may also or alternatively be a complex surface comprising one or more curved or angled features. A side of the demand regulator may generally be defined as an external surface of the demand regulator comprising features facing in one general direction.

The universal connector may be a first universal connector. The first connector point and the second connector point may each be shaped to connect, one at a time, to the first universal connector and to a second universal connector. The second universal connector may have an identical (e.g., substantially, or functionally) shape to the first universal connector. The first universal connector and the second universal connector may be quick connectors or quick connect fittings. Quick connectors will be understood to mean any couplings that provides a mechanical and fluid connection when pushed together. A quick connector may be a tool-less connector.

The first connector point and the second connector point may each comprise a socket into which, one at a time, both the first universal connector and the second universal connector are receivable. Each of the respective sockets of the first connector point and the second connector point may be substantially frustoconical in shape. A socket will be understood to mean any receptacle into which a connector can be received. A socket may have an internal shape or geometry that corresponds to an external shape or geometry of the connector. References to ‘frustoconical shape’ may include connector points with a widest portion distal to the demand regulator and a narrowest portion proximal to the demand regulator.

The first connector point and the second connector point may each comprise one or more sealing surfaces against which each of the first universal connector and the second universal connector may be configured to fluidly seal. The sealing surfaces may be manufactured such that an airtight seal can be formed against them. For example, the sealing surfaces may be manufactured to a particular smoothness.

Both the first connector point and the second connector point may be configured to receive breathing gas via the first universal connector comprised in a breathing gas delivery hose.

Both the first connector point and the second connector point are configured to connect to one or more of a bypass valve and an end cap via the second universal connector comprised in either the bypass valve or the end cap. The second universal connector may be comprised in any other piece of equipment, such as an electrical device, a pressure monitoring device, etc.

The regulator may further comprise a body defining the internal cavity; and a diaphragm disposed in the body. The diaphragm may be in communication with the internal cavity on a first side and may be in communication with an ambient environment on a second side. The manifold may provide fluid communication of breathing gas between the first and second connector points and the internal cavity.

In a further aspect, there is provided a demand regulator system comprising the demand regulator and a universal connector.

The demand regulator system may further comprise a breathing gas delivery hose comprising the first universal connector.

In a first use configuration, the breathing gas delivery hose may be connected to the first connector point of the demand regulator via the first universal connector and the breathing gas delivery hose may extend from the first connector point of the demand regulator in a first direction; and in a second use configuration, the breathing gas delivery hose may be connected to the second connector point of the demand regulator via the first universal connector and the breathing gas delivery hose may extend from the second connector point of the demand regulator in a second direction different to the first direction. The second direction may be opposite to the first direction.

The demand regulator system may further comprise a bypass valve comprising a second universal connector. The second universal connector may have an identical shape to the first universal connector. It will be appreciated that references to ‘identical shape’ may refer to the first and second universal connectors may have functionally identical shapes. That is to say, the shapes of the first and second universal connectors may differ immaterially, so long as functionally the first and second universal connectors are identical.

In the first use configuration, the bypass valve may be connected to the second connector point of the demand regulator via the second universal connector; and in the second use configuration, the bypass valve may be connected to the first connector point of the demand regulator via the second universal connector, such that in both the first use configuration and the second use configuration the breathing gas delivery hose and the bypass valve may extend from the demand regulator in different directions. The different directions may be opposite directions.

In a further aspect, there is provided a breathing apparatus comprising a demand regulator or a demand regulator system. The breathing apparatus may include a tank, a back plate, a pneumatic system, a face mask, an electrical system etc.

### BRIEF DESCRIPTION OF THE DRAWINGS

Arrangements of the invention will now be described, by way of example, and with reference to the accompanying drawings, in which:

FIG. 1 shows a schematic view of a breathing apparatus according to an example arrangement comprising a breathing mask and demand regulator;

FIG. 2 shows a schematic view of a face mask connected to a demand regulator according to the present invention; and

FIGS. 3A and 3B show the demand regulator in two alternative use configurations.

### DETAILED DESCRIPTION OF THE DRAWINGS

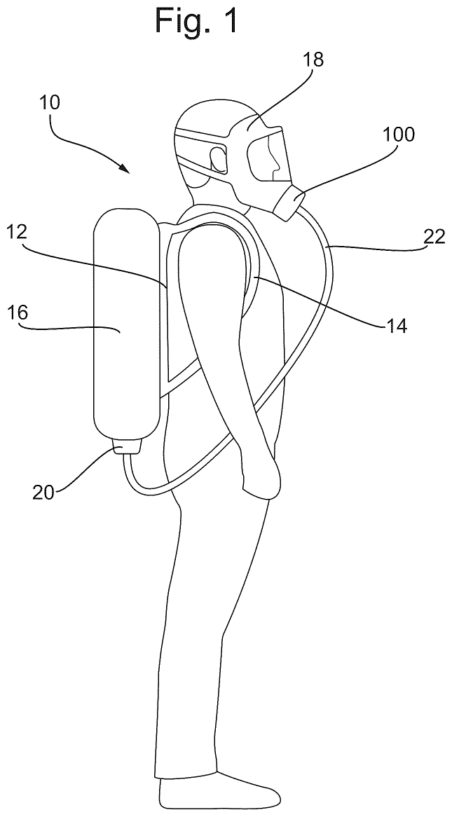

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a hose or flexible conduit 22 to the lung demand regulator 100, to thereby deliver breathing gas to the user wearing the face mask 18 on demand. As shown, the hose 22 may generally be routed around one side of the user's body to the breathing gas cylinder 16. The side of the user's body around which the hose 22 is routed depends on the side of the demand regulator where the hose 22 connects. The present invention provides, amongst other provisions, the ability for the user to select the side of their body around which the hose 22 is routed.

The breathing apparatus 10 may further comprise other components or systems which are not shown, including but not limited to an electrical system, a monitoring system, or a communications system. The lung demand regulator 100 may be referred to as the demand regulator 100 or the regulator 100 throughout.

In this illustrated arrangement, the breathing apparatus 10 is a self-contained breathing apparatus (SCBA), but it should be understood that the lung demand regulator 100 may also have applications in other types of breathing apparatus, such as self-contained underwater breathing apparatus (SCUBA) and emergency escape breathing apparatus.

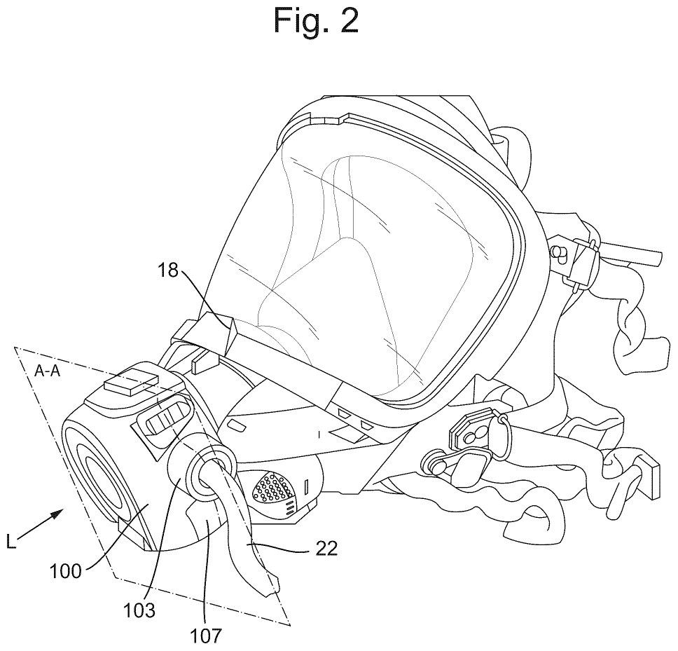

Turning to FIG. 2, a schematic view of a face mask 18 attached to the regulator 100 is shown. A hose 22 of the pneumatics system 20 is connected to a first connector point 101 of the regulator 100 to provide breathing gas from the cylinder 16. The pneumatics system 20 may comprise a first-stage pressure reducer (not shown) which reduces the pressure of the breathing gas from the cylinder 16 which may be stored at several hundred bar, to an intermediate pressure for provision to the regulator 100 via the hose 22. The intermediate pressure may be too high for the breathing gas to be provided directly to the user to breathe. The regulator 100 or the pneumatic system 20 may further comprise a second-stage pressure reducer (not shown) which further reduces the pressure of the breathing gas to a suitable pressure for delivery to the user to breathe. In other arrangements, more than two or fewer than two pressure reducers may be provided. In some arrangements, the regulator 100 is connected to a pressurised breathing gas circuit such as a ring main for workers to use (e.g., in a factory). In this case, the breathing gas may be provided by the circuit at a breathable pressure and so a pressure reducer may not be required.

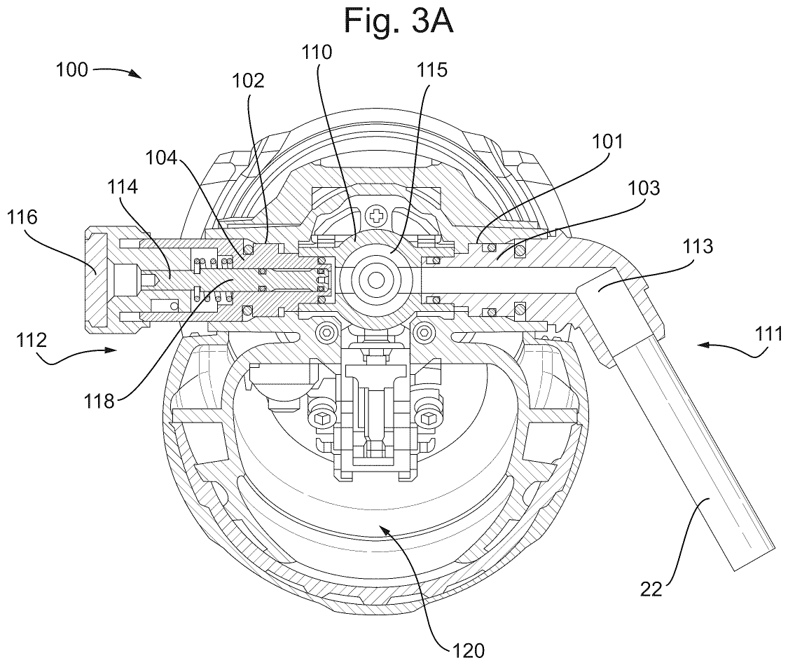

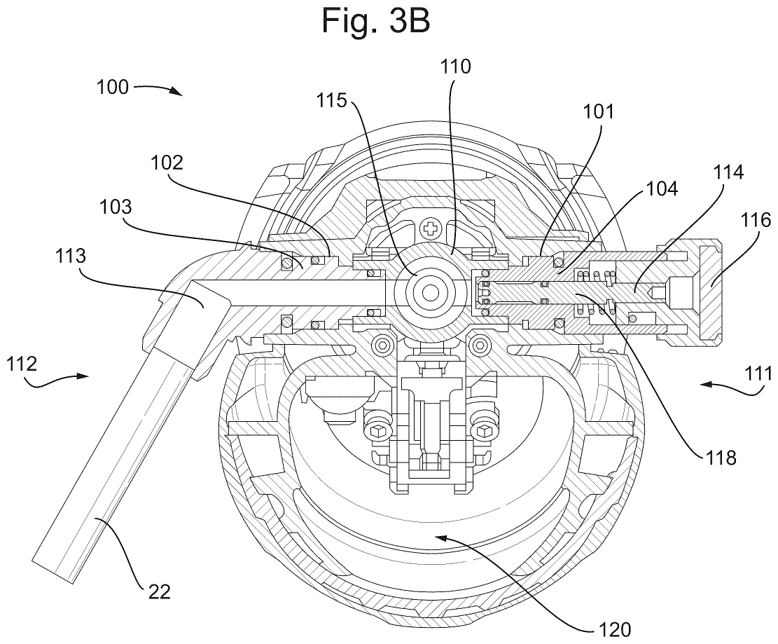

Turning to FIG. 3A, an exemplary embodiment of the present disclosure is shown. FIG. 3A shows a cross sectional view of the regulator 100, marked as A-A in FIG. 2. This cross sectional view shows the regulator 100 in a first use configuration. The regulator 100 comprises a first connector point 101 and a second connector point 102. The first connector point 101 and the second connector point 102 are each configured to connect to a universal connector.

The first connector point 101 and the second connector point 102 are each positioned at different positions on the regulator 100. The first connector point 101 and the second connector point 102 are each configured to connect to a universal connector (103, 104). In other words, the first and second connector points 102 may be shaped (e.g., comprise the same internal and/or external geometry) to connect to a respective universal connector (103, 104) with a complementary shape. In some examples, the regulator 100 may comprise more than two connector points, for example three, four, or five connector points.

In some examples, the first connector point and the second connector point are male connectors which can be received by a female universal connector. Such male connectors may extend outwards from the regulator 100. In other examples, including the example shown in FIG. 3A, the first connector point 101 and the second connector point 102 are female ports (e.g., sockets or receptacles) into which a male universal connector 103 can be received. Such female ports may be recessed in the regulator 100. The first connector point 101 and the second connector point 102 each define a respective insertion axis along which the universal connector 103 can be received. The first connector point 101 and the second connector point 102 are generally positioned facing outwards from the regulator 100. Thus, the respective insertion axes of the first and second connector points 101, 102 generally extend away from the regulator 100 in different directions. In some examples, including the example shown, the first connector point 101 and the second connector point 102 are positioned to face in generally opposite directions, with the respective insertion axes extending in opposite directions. In this way, the universal connector 103 can be received by the first connector point 101 from one direction and from another opposite direction by the second connector point 102. In this example, the first and second connector points 101 and 102 are generally arranged on the regulator such that, in use, they are arranged on left and right sides of the regulator 100, respectively. As the universal connectors 103 and 104 are comprised in a breathing gas delivery hose 22 and a bypass valve 114 respectively, the positions of the hose 22 and the bypass valve 114 on the regulator 100 can be altered by connecting them to one or other of the first and second connector points 101, 102. In some examples, the hose 22 includes an elbow element 113 which changes the direction of the hose 22 relative to the connector point 101.

As mentioned above, both the first connector point 101 and the second connector point 102 each have the same shape. In other words, the geometries of each of the first and second connector points 101, 102 are substantially the same, and therefore each of the first and second connector points 101, 102 are capable of connecting to connectors of the same shape (such as the universal connector 103). In the example shown, the first connector point 101 and second connector point 102 each comprise a socket (i.e., a receptacle) which is generally frustoconical in shape with a widest portion distal to the regulator 100 and a narrowest portion proximal to the regulator 100. The internal sides of the first and second connector points 101, 102 can be smooth and/or otherwise sloping. In the example shown, the internal sides are stepped such that there are a plurality of surfaces facing perpendicularly to the insertion axis of each of the first and second connector points 101, 102 and a plurality of surfaces facing parallel to the insertion axis of each of the first and second connector points 101, 102. The perpendicularly and/or parallel facing internal surfaces may serve the purpose of acting as an abutment for the universal connector 103, when inserted, to prevent over insertion. The perpendicularly and/or parallel facing internal surfaces may alternatively or additionally serve the purpose of acting as a sealing surface against which an airtight seal with the universal connector 103 can be formed. The internal surfaces of the first and second connector points 101, 102 may be manufactured and/or otherwise prepared to a smoothness suitable for a secure airtight seal to be formed against the internal surfaces.

The regulator 100 comprises a diaphragm (not shown) which is exposed to the ambient environment on one side and to an internal cavity 120 of the regulator 100 on the other. As the user inhales, the pressure inside the internal cavity 120 decreases, causing the diaphragm to flex into the internal cavity 120. This flexing of the diaphragm in turn causes a valve (not shown) to introduce breathing gas supplied from the hose 22 into the internal cavity 120 via the universal connector 103 and the first connector point 101 (or second connector point 102). As breathing gas is introduced to the internal cavity 120, the pressure in the internal cavity increases, causing the diagraph to flex outwards, thereby closing the valve.

The universal connector 103 connected to the hose 22 can be connected (and thereby provide breathing gas) to both, one at a time, the first connector point 101 and the second connector point 102. FIG. 3A shows the universal connector 103 connected to the hose 22 being connected to the first connector point 101. To enable breathing gas to be received at both the first and second connector points 101, 102, a manifold 110 is provided in the regulator 100. The manifold 110 enables breathing gas to flow between the first connector point 101, the second connector point 102, and the internal cavity 120. In some examples, the regulator 100 may include a regulator valve 115 which controls the introduction of breathing gas into the internal cavity 120 from the manifold 110. The manifold 110 may permit the flow of breathing gas between the first and second connector points 101, 102. In some examples, the valve 115 is provided between the manifold 110 and the internal cavity 120 or as part of the manifold 110, such that the valve 115 controls and/or restricts the flow of breathing gas into the internal cavity 120.

In some examples, including the example shown in FIG. 3A, the first connector point 101 is disposed on a first lateral side 111 of the regulator 100 and the second connector point 102 is disposed on a second lateral side 112 of the regulator 100. A lateral side should be understood to mean a side of the regulator 100 that is not the top, bottom, front, or back of the regulator 100. The first lateral side 111 will generally be opposite the second lateral side 112 and may also be substantially parallel to the first lateral side 111. The first and second lateral sides 111 and 112 may be the left and right sides (or vice versa) during use of the regulator 100.

FIG. 3A shows the second connector point 102 occupied by a second universal connector 104. The second universal connector 104 has a functionally identical shape to the first universal connector 103. In this way, the universal connector 103 discussed above can be considered a first universal connector 103 (as it will be referred to from here on). Like the first universal connector 103, the second universal connector 104 can be used to connect any piece of equipment to the regulator 100. FIG. 3A shows a bypass valve 114 comprising the second universal connector 104, connected to the second connector point 102. A bypass valve 114 is a safety device which enables the user to be provided with a supply of breathing gas, not dependent on the operation of the valve and/or diaphragm of the regulator 100. In this way, if there is a problem with the demand regulating function of the regulator 100 such that it is not adequately supplying breathing gas on demand to a user, then the bypass valve 114 can be used to circumvent or override the demand regulating system (which may include valve 115, diaphragm etc.) and provide a constant supply of breathing gas to the user. The bypass valve 114 includes a button 116 which can be depressed by the user to activate the bypass function. Once the button 116 is depressed, a rod 118 is actuated which pushes on the valve 115 of the regulator 100 causing it to be held open. The manifold 110 therefore provides space for the rod 118 of the bypass valve 114 to move freely whether the bypass valve 114 is installed in either the first connector point 101 or the second connector point 102. It will be appreciated by the skilled person that, where other regulator valve arrangements are used, the precise construction of the bypass valve may be different.

It will be appreciated that in some examples, the first and second universal connectors may have different shapes or configurations, provided so long as functionally they are identical in so far as connecting with the first and second connector points. That is to say that the first and second universal connectors must only be identical to the extent that they can each form a sealing connection with each of connector points in a modular fashion. Specifically, any part of the first universal connector that is designed for connecting and/or sealing with the first and second connector points may be functionally identical to the corresponding part on the second universal connector. However, parts of the connectors without connecting function may differ between the first and second universal connectors. For example, the first connector 103 is of ‘elbow’ form and comprises a through bore for permitting the transport of breathing gas therethrough from a source, while the second connector 104 of the bypass valve 114 is substantially straight and contains valve components. However, each the structure of each of the connectors 103 and 104 if configured such that each connector 103, 104 can be connected to either of the first and second connector points 101 and 102. Furthermore, the skilled person will appreciate that the first and second connector points may differ in non-functional ways.

In some examples, the first and/or second connector points and/or the first and/or second universal connectors may be keyed such that the first and/or second universal connectors may be required to be inserted in a particular rotational orientation. In some examples, the first and second connectors and the first and second connector points may be threaded such that the first and second connectors can be screwed into the first and second connector points. Other means of securing the first and second connectors are envisaged, for example bayonet style or friction fit style securement means.

In some examples, for example where a bypass valve 114 is not required, the second universal connector 104 may be comprised in an end cap. The end cap (or alternatively a ‘blanking cap’) may seal off the unused connector point on the regulator 100 such breathing gas cannot escape from the manifold 110 via the unused connector point. An unused connector point may be either of the first or second connector points 101, 102 which is not occupied by a universal connector connected to a hose 22 or another piece of equipment.

In some examples, the first and second universal connectors 103, 104 are quick connectors or quick connect fittings. Such quick connectors may enable the user to rapidly disconnect and reconnect the first and second universal connectors 103, 104 from the first and second connector points 101, 102.

Other examples of equipment that could be connected to the regulator 100 using a universal connector via the first and/or second connector points 101, 102 include a pressure gauge, a second breathing gas supply (via a further hose), or an electronic device such as a torch. It will be appreciated that a piece of equipment may form only a mechanical connection with the first and/or second connector points 101, 102 rather than also forming a fluid path for breathing gas to flow.

In some examples, the first and/or second connector point and/or the first and/or second universal connector may be keyed such that only a subset of the different pieces of equipment comprising a first and/or second universal connector may be connectable to both the first and second universal connectors. In this way, pieces of equipment that are required to be connected to a particular one of the first and second connector points can be prevented from connecting to the incorrect connector point. Such pieces of equipment may be referred to a ‘non-universal’. By preventing such pieces of equipment from connecting incorrectly to the regulator, the regulator may prevent damage occurring.

FIG. 3B shows a second cross sectional view of the regulator 100, marked as A-A in FIG. 2. FIG. 3B shows the regulator 100 in a second use configuration, alternate to the first use configuration of FIG. 3A. This second use configuration is identical to the first use configuration shown in FIG. 3A, apart from the first universal connector 103 being connected to the second connector point 102 and the second universal connector 104 being connected to the first connector point 101. In the first use configuration, the hose 22 is generally routed around the left side of the user's body as the hose 22 extends from the first connector point 101, which is on the first lateral side 111, on the left of the regulator 100. In the second use configuration, the hose 22 extends from the second lateral side 112 and is therefore routed around the right side of the user's body. Equally, in the first use configuration, the bypass valve 114 and its button 116 is easily accessible by the right hand of the user, while in the second use configuration, the bypass valve 114 and its button 116 is easily accessible by the left hand of the user.

By changing which of the first and second connector points 101, 102 receives each of the first and second universal connectors 103, 104, the user is able to customise how the hose 22 is routed around their body. The user is therefore also able to select which hand is able to easily access the bypass valve 114 and its button 116. In this way, the user is able to customise the breathing apparatus system 10 according to their own preferences. Specifically, the user is able to customise the breathing apparatus system 10 according to which of their hands is their dominant hand. This customisation is possible while maintaining full functionality of both of the first and second connector points 101, 102 and the regulator 100 itself. This functionality also enables a more flexible and ‘future-proof’ regulator 100, which can adapt as newer equipment is developed, which may benefit from there being a second connector point 102 on the regulator 100.

As noted above, regulators such as the regulator 100 disclosed herein, are often used by firefighters. Fire brigades will usually have fewer breathing apparatus systems available than firefighters and therefore firefighters will often be required to share breathing apparatus systems. The present disclosure enables each firefighter to rapidly customise the configuration of a breathing apparatus system for use with their regulator such that it is optimal for their use, regardless of the configuration used by the previous firefighter. Therefore, the present disclosure enables firefighters to respond more quickly to emergency situations, thus improving emergency response outcomes.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A demand regulator (100) for a breathing apparatus comprising:
a first connector point (101); and
a second connector point (102),
wherein the first connector point (101) and the second connector point (102) are each configured to connect to a universal connector (103, 104).

2. The demand regulator (100) of claim 1, wherein the first connector point (101) and the second connector point (102) each have an identical shape.

3. The demand regulator (100) of claim 1 or 2, wherein the first connector point (101) and the second connector point (102) are each in fluid communication with a manifold (110) of the demand regulator (100) and an internal cavity (120) of the demand regulator (100) via the manifold (110), such that breathing gas is permitted to flow between both the first connector point (101) and the second connector point (102) and the internal cavity (120) via the manifold (110).

4. The demand regulator (100) of any of the preceding claims, wherein the first connector point (101) and the second connector point (102) are on opposite sides of the demand regulator (100), and optionally wherein the first connector point (101) and the second connector point (102) are positioned on the demand regulator (100) facing in substantially opposite directions.

5. The demand regulator (100) of any of the preceding claims, wherein the first connector point (101) is disposed on a first lateral side (111) of the demand regulator (100) and the second connector point (102) is disposed on a second lateral side (112) of the demand regulator (100) opposite the first lateral side (111).

6. The demand regulator (100) of any of the preceding claims, wherein the universal connector (103, 104) is a first universal connector (103), and wherein the first connector point (101) and the second connector point (102) are each shaped to connect, one at a time, to the first universal connector (103) and to a second universal connector (104) having an identical shape to the first universal connector (103), optionally wherein the first universal connector (103) and the second universal connector (104) are quick connectors.

7. The demand regulator (100) of claim 6, wherein the first connector point (101) and the second connector point (102) each comprise a socket into which, one at a time, both the first universal connector (103) and the second universal connector (104) are receivable, optionally wherein each of the respective sockets of the first connector point (101) and the second connector point (102) are substantially frustoconical in shape.

8. The demand regulator (100) of claim 6 or 7, wherein the first connector point (101) and the second connector point (102) each comprise one or more sealing surfaces against which each of the first universal connector (101) and the second universal connector (102) are configured to fluidly seal.

9. The demand regulator (100) of any of claims 6-8, wherein both the first connector point (101) and the second connector point (102) are configured to receive breathing gas via the first universal connector (103) comprised in a breathing gas delivery hose (22).

10. The demand regulator (100) of any of claims 6-9, wherein both the first connector point (101) and the second connector point (102) are configured to connect to one or more of a bypass valve (114) and an end cap via the second universal connector (104) comprised in either the bypass valve (114) or the end cap.

11. A demand regulator system (200) comprising the demand regulator (100) of any of the preceding claims and a universal connector (103, 104).

12. A demand regulator system (200) as claimed in claim 11, further comprising a breathing gas delivery hose (22) comprising the first universal connector (103).

13. The demand regulator system (200) of claim 12, wherein:
in a first use configuration, the breathing gas delivery hose (22) is connected to the first connector point (101) of the demand regulator (100) via the first universal connector (101) and the breathing gas delivery hose (22) extends from the first connector point (101) of the demand regulator (100) in a first direction; and
in a second use configuration, the breathing gas delivery hose (22) is connected to the second connector point (102) of the demand regulator (100) via the first universal connector (103) and the breathing gas delivery hose (22) extends from the second connector point (102) of the demand regulator (100) in a second direction different, optionally opposite, to the first direction.

14. The demand regulator system (200) of claim 13, further comprising a bypass valve (114) comprising a second universal connector (104) having an identical shape to the first universal connector (103), wherein:
in the first use configuration, the bypass valve (114) is connected to the second connector point (102) of the demand regulator (100) via the second universal connector (104); and
in the second use configuration, the bypass valve (114) is connected to the first connector point (101) of the demand regulator (100) via the second universal connector (104),
such that in both the first use configuration and the second use configuration the breathing gas delivery hose (22) and the bypass valve (114) extend from the demand regulator (100) in different, optionally opposite, directions.

15. A breathing apparatus (10) comprising the demand regulator (100) of claims 1-10 or the demand regulator system (200) of claims 11-14.
